(19) United States
(12) Patent Application Publication
(10) Pub. No.: US 2009/0229839 A1
(43) Pub. Date: Sep. 17, 2009

(54) Extinguisher Pressure Control Device

(75) Inventor: Benigno Garcia Calvo, Mansilla De Las Mulas (León) (ES)

Correspondence Address: WENDEROTH, LIND & PONACK, L.L.P., 1030 15th Street, N.W.,, Suite 400 East, Washington, DC, 20005-1503, US

(73) Assignee: CONTROL FIABLE DE PRESION, S.L., Mansilla De Las Mulas (Leon) (ES)

(21) Appl. No.: 12/294,999

(22) PCT Filed: May 26, 2006
(86) PCT No.: PCT/ES2006/000299

§ 371 Date: Mar. 12, 2009

(30) Foreign Application Priority Data
Mar. 31, 2006 (ES) U200600777

(51) Int. Cl. A62C 13/76

(52) U.S. Cl. 169/30

(57) ABSTRACT

The extinguisher comprises, in principle, a bottle that contains an extinguishing agent and a head for controlling pressure and dispersion of the extinguishing material. It is characterized in that it comprises and electrical circuit (1) with at least one activator contact (4) associated with the pressure of a small chamber inside the head (2), such that when said pressure reaches at least a preset minimum value the circuit (1) is closed and a signal connected to the electrical circuit (1) is maintained activated, said circuit being powered by batteries, a storage battery or even the actual electric mains or the like.

### OBJECT OF THE INVENTION

As expressed in the title of the present specification, the following invention refers to an extinguisher pressure control device comprising, in principle, a bottle and a head, through which the dispersion of the extinguishing agent contained inside the bottle is regulated.

The head also comprises means for controlling the pressure of the extinguisher at all times in order to ensure its effectiveness.

Based on this premise, the innovation contributed by the present invention resides in a new advantageous verification system for the pressure inside the extinguisher that ensures the effectiveness of the extinguisher at any time.

This new pressure verification system is more visible even in conditions where light is scarce.

### BACKGROUND OF THE INVENTION

Conventional extinguishers operate in the following basic manner: an extinguishing agent is introduced in the container. This agent can be solid, liquid or gaseous. Then pressure is incorporated to the container so when a product release valve is activated the product is expelled out of the recipient and sprayed towards the fire.

There are very rigorous inspection measures in place to ensure, insofar as possible that said pressure remains inside the container, otherwise the extinguisher would cease to be operative.

To be able to know after a visual inspection whether the extinguisher is in good working order it is necessary to verify the pressure inside by inspecting a pressure manometer.

This requires the intentionally reading said manometer to verify that it indicates the minimum required pressure. However, this pressure manometer device is not a very reliable instrument for the following reasons:
The indicator arm of the manometer may be stuck in the high pressure level zone and this may prevent the indicator arm from returning to the low or null pressure zone or band and therefore the manometer will offer an erroneous reading of the extinguisher activity.
Another reason is due to market imperatives. Competitiveness based in low costs means that savings tend to impact in the quality-price ratio, which obviously has repercussions in terms of extinguisher safety.

### DESCRIPTION OF THE INVENTION

In order to attain the objectives and avoid the disadvantages mentioned in previous sections, the present invention proposes an extinguisher which head incorporates a new device to complement the absolute assurance we must have in terms of the extinguishers being operative when they are required and also, and obviously, at any time even when they are not going to be used.

The head incorporates in its interior a small pressure chamber that communicates with the inside of the extinguisher, in such a way that to control said pressure and know whether is the correct pressure in order to ensure the extinguisher is operative, said small chamber inside the head is associated with a threaded tubular ending where a small manometer is connected, the small manometer reading the real pressure of the extinguisher.

Based on this premise, the extinguisher of the invention is characterized in that the pressure chamber inside the head is associated to an electric circuit having at least one light and/or acoustic signal, and said circuit incorporating at least one contact associated to the extinguisher pressure, so that when said pressure reaches a preset minimum value, said contact is closed keeping the light and/or acoustic signal activated by means of a power supply, such as a battery, a storage battery or even the actual electric mains; while in the case of said pressure not reaching said preset minimum value, the contact is opened and the signal is not activated, indicating that the extinguisher is not operative, or at least is not 100% operative as required by the strict extinguisher legislation.

The advantages offered by the present invention in terms of complementing the manometer action, or if appropriate substituting it, are as follows:
The pressure status or perfect operativity of the extinguisher can be verified without having to get physically close to it, because if the light is not on then it would unequivocally signal the lack of pressure inside the container and therefore the lack of functionality of the extinguisher.
The pressure at which the light turns on or off can be set to exact pressure values, since it can simply be chosen that in an interval of for instance 7 kg/cm2 or more, a Light Emitting Diode (LED) can be set in order to turn on and to turn off when the pressure goes below 7 kg/cm2, while conventional nanometers do not have such accuracy because they move within a measurement arc lacking precision.
In the event of a fire, or in dark areas, or areas with little visibility, we may not be able to locate the extinguisher because of these poor light conditions. In these cases the flashing of the light signal or the noise of the acoustic signal will make finding the extinguisher easier and will lead someone to it.
One will eventually get used to see this light in an unconscious manner and it will catch its attention when the acoustic signal (buzzer) ceases to emit a tone.

On the other hand, conventional extinguishers are subject to periodical check ups, generally once a year, to verify their operational status. The system of the present invention ensures—both for the inspector and the user—the operational readiness of the extinguisher. If the annual check up does not take place for any circumstance whatsoever—negligence or forgetfulness or similar—and the battery or storage battery that keeps the light signal or the acoustic signal operating would run out, the signal would not operate. But the invention, anticipating this circumstance, incorporates the provision that the battery will run out after this established time, not providing power to operate the light or acoustic signal and therefore indicating that there is no pressure inside the extinguisher and/or that the inspection period has expired.

The next section, which is an integral part of this descriptive report, is an explanation of the present invention related to the attached drawings for a better understanding of the concept and is intended as illustrative and not limiting of the scope of the present invention.

### BRIEF DESCRIPTION OF THE DRAWINGS

FIG. 1. Shows a view of an extinguisher which head incorporates the pressure control device object of the invention. It comprises basically an electrical circuit having at least one contact associated to the pressure of the extinguisher to know whether the extinguisher is operative or not.

FIG. 2. Shows a schematic view showing how the device object of the invention is activated to show the operational readiness of the extinguisher.

FIG. 3. Shows a schematic view showing the lack of the effectiveness of the extinguisher.

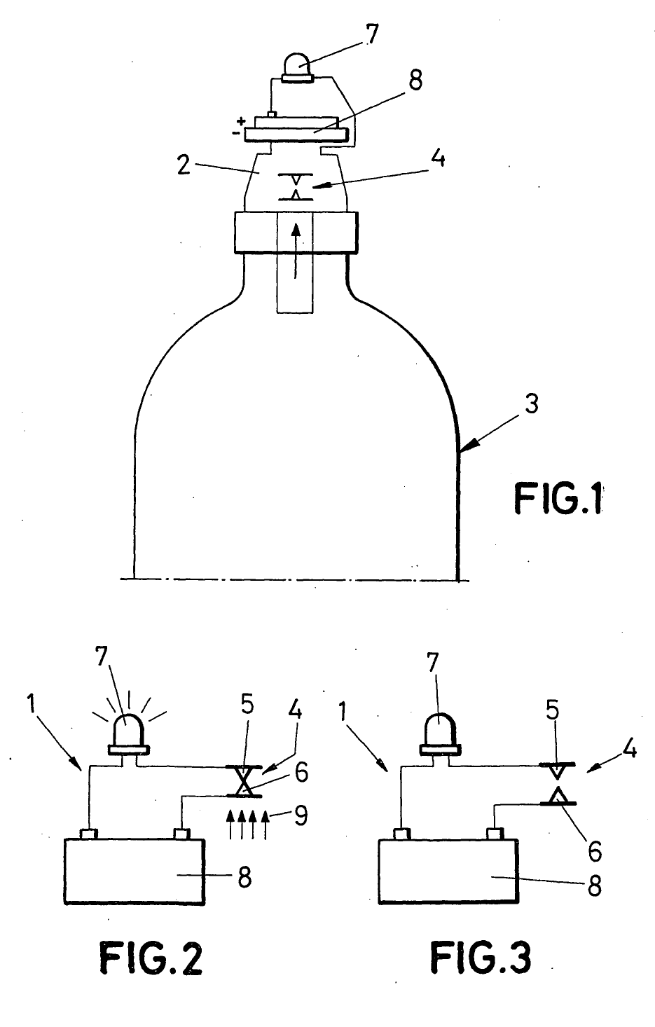

### DESCRIPTION OF THE PREFERRED EMBODIMENT

Using as reference the numbering shown in the figures, the extinguisher pressure control device is determined from a small electrical circuit 1 associated to a head 2 of an extinguisher 3 that has a contact 4 with a fixed part 5 and a mobile part 6, where the contact 4 is associated to a small pressure chamber contained inside the head 2, and said chamber is connected to the inside of the extinguisher 3 to verify whether it is operative by verifying there is pressure inside the extinguisher receptacle in such a manner that there is minimum preset pressure inside the chamber inside head 2, the electric contact is set to the closed position in which a small light element, such as a Light Emitting Diode (LED), 7 will turn on, ensuring the extinguisher is operative.

In the opposite situation, when the chamber inside head 2 of extinguisher 3 does not reach said minimum preset pressure, the light signal 7 will turn off, indicating the extinguisher is not operative, or at least, not 100% operative as required by the strict current legislation regulating extinguishers. In this situation of lack of operational functionality, the possibility also exist of activating a second light signal of a different color or even an acoustic signal, such as a buzzer, to alert of this situation.

Generally power is supplied to circuit 1 by a small battery 8 that will last for a period exceeding the period assigned for periodical extinguisher inspections and that will be replaced for a new one at each of said checks if it is used as the power supply for the device.

1. EXTINGUISHER PRESSURE CONTROL DEVICE, comprising a bottle containing an extinguishing agent and a head for controlling pressure and dispersion of the extinguishing material, characterized in that it comprises an electrical circuit (1) with at least one activating contact (4) associated to the pressure of a small chamber inside the head (2), such that when said pressure reaches at least a preset minimum value the circuit (1) is closed and a signal connected to the electrical circuit (1) is maintained activated, said circuit being powered by batteries, storage batteries or even the actual electric mains or the like.

2. EXTINGUISHER PRESSURE CONTROL DEVICE according to claim 1, characterized in that the operativity signal comprises essentially a Light Emitting Diode (LED) (7) that is turned on when the extinguisher is operative and turned off when the extinguisher is not operative.

3. EXTINGUISHER PRESSURE CONTROL DEVICE according to claim 1, characterized in that when the pressure inside the head does not reach the preset minimum pressure a second signal is activated, for instance a sound signal or even a light signal having a different color from the first light signal.

4. EXTINGUISHER PRESSURE CONTROL DEVICE according to claim 2, characterized in that when the pressure inside the head does not reach the preset minimum pressure a second signal is activated, for instance a sound signal or even a light signal having a different color from the first light signal.
